(19) United States
(12) Patent Application Publication
(10) Pub. No.: US 2008/0278516 A1
(43) Pub. Date: Nov. 13, 2008

(54) System and method for adjusting perceived eye rotation in image of face

(76) Inventor: John C. Santon, Vista, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/801,832

(22) Filed: May 11, 2007

(51) Int. Cl. G09G 5/00

(52) U.S. Cl. 345/619

(57) ABSTRACT

Various embodiments of a method for changing the perceived view direction in an image of a person's face are disclosed.

### BACKGROUND

Videophones are intended to allow two users at remote locations to see each other while talking. To that end, a videophone has a display and a camera. Both the camera and the display face the user. The user looks at the display while the camera captures an image of the user looking at the display. One characteristic of this type of system is that the captured images are of a user that is not looking directly at the camera. Instead, the user is looking at the image on the display, which is some distance away from (usually below) the camera. Thus the users do not experience eye contact.

Videophone manufacturers have tried to address this issue through hardware. For example, one approach is to mount the camera and display close to each other. This approach tends to reduce the deviation of the user's gaze, but does not eliminate it. Other approaches have attempted to use reflections or beam splitters to allow eye contact. Still other approaches have used Fresnel lenses and semi-reflective mirrors to provide perceived eye contact. Each of these approaches involve additional or modified hardware, and thus present a significant expense, and can also affect the size of the videophone hardware.

### BRIEF DESCRIPTION OF THE DRAWINGS

Various features and advantages of the present disclosure will be apparent from the detailed description which follows, taken in conjunction with the accompanying drawings, which together illustrate, by way of example, features of the disclosure, and wherein:

FIG. 1 is an illustration of a person using a videophone system having a video display and camera;

FIG. 2 is a diagram of a triangle that illustrates the geometry of the videophone arrangement of FIG. 1;

FIG. 3 is an illustration of eye spacing;

FIG. 4 is a diagram of nested similar triangles that illustrate how the distance from the video display is determined based upon the graphically detected eye spacing;

FIG. 5 is an illustration of the geometry of the human eyeball in level and rotated positions;

FIG. 6 is a diagram of a triangle that illustrates the geometry of the eyeball as shown in FIG. 5;

FIG. 7 is an unaltered image of a person as would be seen using a videophone system like that shown in FIG. 1;

FIG. 8 is an image of a person in which the eye position has been adjusted in accordance with the present disclosure;

FIG. 9 shows how the eye position can be adjusted by cutting and pasting a rectangular block of the image in accordance with the present disclosure;

FIG. 10 shows how the eye position can be adjusted by cutting and pasting a circular block of the image in accordance with the present disclosure;

FIGS. 11a and 11b depict an alternative method for adjusting the eye position and smoothing the surrounding image; and

FIG. 12 is a flowchart showing the steps in one embodiment of a method for adjusting perceived eye rotation in an image of a face.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the inventive features illustrated herein, and additional applications of the principles illustrated herein, which would occur to one skilled in the relevant art and having possession of this disclosure, are to be considered within the scope of this disclosure.

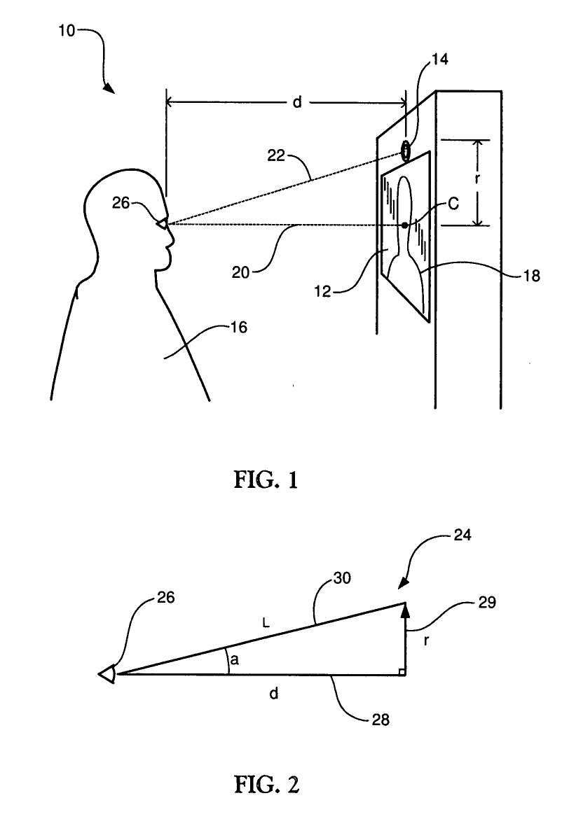

The present disclosure relates to a system and method for modifying captured images in a videophone system. An example of a videophone system 10 is shown in FIG. 1. The system generally includes a video display 12 and a camera 14 that is positioned adjacent to the display. In this case the camera is above the display. A user 16 views an image of another user 18 on the display, while an image of the user is being taken by the camera. For purposes of this discussion, both participants in the videophone conference are presumed to be using videophone systems having similar geometry.

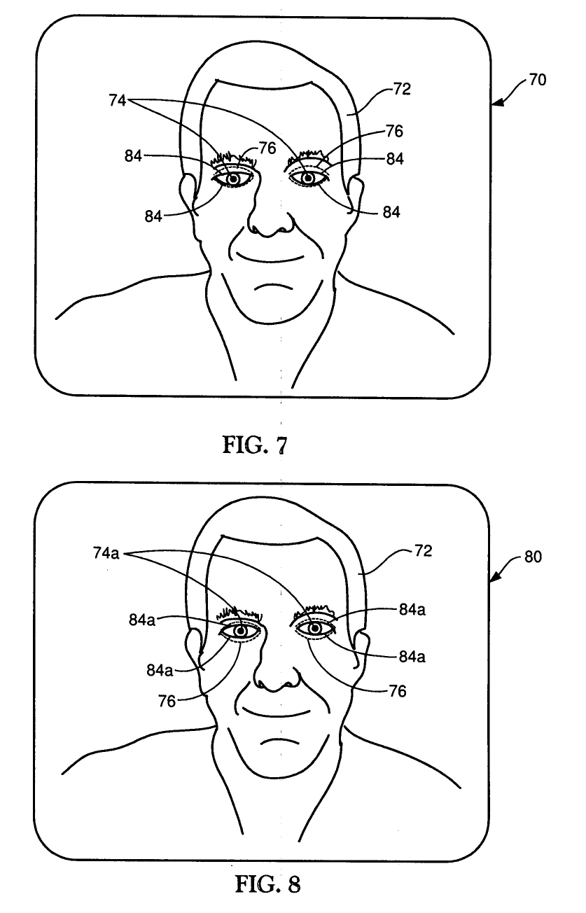

In this configuration, since the camera 14 is a distance r above the center of the video display 12, each user 16, 18 will not be looking directly at the camera. Instead, the eyes 26 of each user look approximately at the center of the display (designated point C) along line 20, while the camera takes an image of the user from above along line 22. Consequently, the image of the user that is provided to the other user will be of a person that is not looking directly at them as shown by the display. An image 70 of a person 72 as would be seen using a videophone system like that shown in FIG. 1 is provided in FIG. 7. Here it can be seen that the person's eyes 74 are looking downward relative to the point of view of the camera. An outline of the person's eye region 76 is provided to help illustrate the downward cast of the eyes. This prevents the users in a videophone setting from experiencing eye contact, which detracts from the quality of the videophone experience.

There are a number of approaches that have been tried for allowing apparent eye contact in a videophone situation. Many previous approaches to this situation involve mirrors, beam splitters, or other hardware, which can be expensive and large. Advantageously, the inventors have developed a software method that adjusts the perceived eye rotation of an image of a face, so that additional hardware is not needed to provide the appearance of an eye-to-eye videophone experience. The method involves modifying a captured image of a face, so that the user appears to be looking directly at the camera. This method can be accomplished in a fast microprocessor, for example, or using a small amount of dedicated electronics, and does not require additional large or expensive hardware.

Shown in FIG. 2 is a diagram of a right triangle 24 that illustrates the geometry of the videophone arrangement of FIG. 1. The center C of the display is the presumed focal point for the user. The eye 26 of the user is represented at the acute vertex of the triangle. The user looks toward the center C of the display along the horizontal side 28 of the triangle (corresponding to line 20 in FIG. 1). This line has length d, which represents the distance between the center of the display C and the user's eyes. At the same time, the camera views the user's eye along the sloped side 30 of the triangle (corresponding to line 22 in FIG. 1), from a point that is a distance r vertically above the center C of the display. The line of sight of the camera makes an acute angle a with respect to the user's gaze.

Where the distance r is fixed, the angle a can be easily determined if the distance d is also known. Determining this distance can be accomplished through the use of various hardware devices, such as sonar range finders, optical distance measuring devices, and the like. Such approaches are to be considered within the scope of this disclosure.

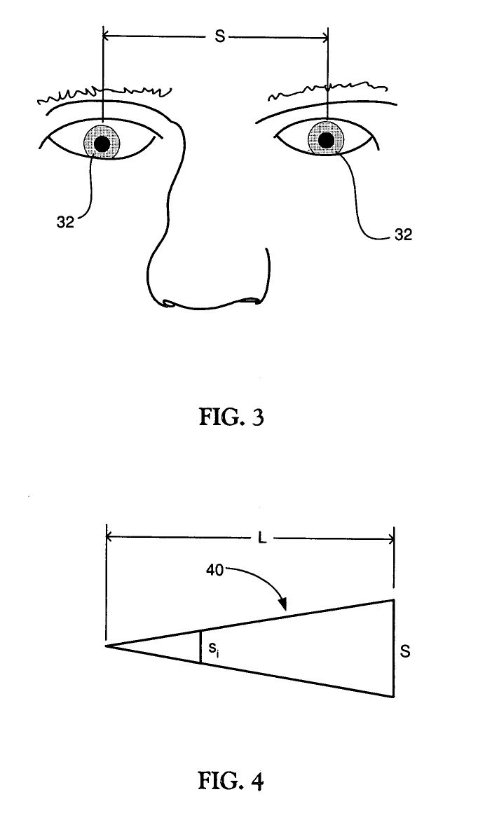

However, the inventors have also developed a solution that does not require additional hardware. There currently exists facial recognition software that can analyze the image of a human face and determine where the irises are. For example, software for red eye correction in facial images in digital photographs uses facial recognition algorithms that locate the irises in a person's face. This type of software can be used in a video conference system as disclosed herein. An illustration of a pair of eyes 32 is shown in FIG. 3. The center of the eyes are separated by a distance S. While the eye separation distance varies slightly from person to person, the average eye separation S for an adult is about 70 mm.

Knowing this value allows the facial recognition software to determine the distance d from the camera 14 to the eyes 26 of the person. This distance can be calculated using similar triangles 40 in a manner illustrated in FIG. 4. The facial recognition software first identifies and locates the eyes in the facial image, then directly measures the graphical distance sᵢ between the centers of the eyes (e.g. a distance in pixels). Assuming that the actual distance S between the user's eyes is about 70 mm, and knowing the optical properties of the camera system (e.g. focal length, etc.), the distance L can be determined using elementary trigonometry for similar isosceles triangles in the manner shown in FIG. 4. The distance L will be equal to the height of the large isosceles triangle 40 having equal sides originating from the camera (at point 42), and a short side having length S. This short side is coincident with a line between the centers of the user's eyes. This length L is the same as the length L of the hypotenuse 30 of the right triangle 24 in FIG. 2. Knowing the height r and the length L allows a direct determination of the distance d that represents the location of the user's eyes, and the angle a at the acute end of the triangle.

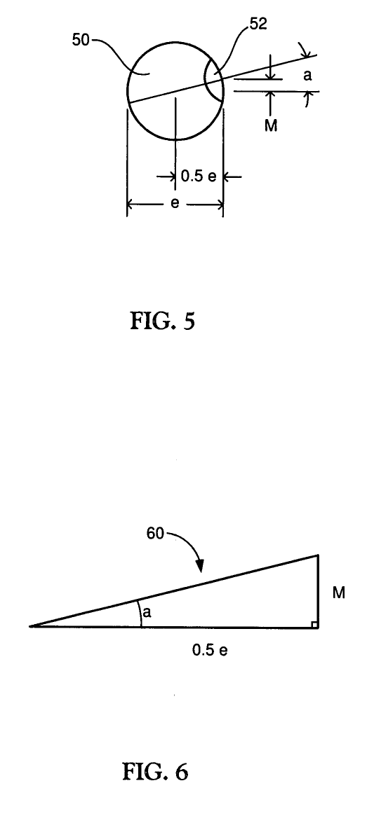

Once the distance d between the display and the user is known, along with the angle a, the next step requires some knowledge of the human eye. An approximate side view of a human eye 50 is shown in FIG. 5. The eye of an average human adult has a diameter e that is about 30 mm. In FIG. 5 the eye is shown rotated, with the iris 52 pointing upward, as when the individual is looking up. When the iris is deflected upward some angle a, the center of the iris will move linearly upward a distance M. This distance M can be calculated according to the equation

M=(r*e)/(2*d) (eq. 1.0)

where d equals the distance between the display and the subject, r equals the distance between the camera and the center C of the display, and e equals the diameter of a typical adult human eye. The multiplier of 2 comes in because the distance M depends upon half the diameter of the eye, as shown in FIG. 6. The distance M represents the short side of a right triangle 60 having a long side of length 0.5 e, and an acute angle a. It will be apparent that because the angle a is the same in this figure as in FIG. 2, this triangle will be similar to the triangle 24 in FIG. 2, and equation 1.0 above thus represents a solution for similar triangles, in which the angle a is not needed for the solution.

The magnitude of M given by equation 1.0 is the distance that the iris needs to be moved in units of millimeters measured at the position of the eye of the person. In order to make the appropriate adjustment to the image of the person, the dimension M needs to be converted to equivalent units of pixels at the position of the camera, which depends upon the optical characteristics of the camera, which are constant, and the distance of the person from the camera, which can vary. This distance can be determined using a similar triangle solution like that shown with respect to the triangle 40 in FIG. 4. In this case, the distance L is already known, and the distance M in millimeters at the eye corresponds to the length S of the larger triangle. The equivalent distance in pixels that the image of the eye must be moved, Mᵢ, corresponds to the length sᵢ of the smaller side. The dimension sᵢ can be determined based upon the known optical and other properties of the camera and imaging system. Thus for a given shift distance M (in mm at the eye), the magnitude of the image shift in pixels, Mᵢ, will be larger as L decreases (i.e. the person is closer to the camera), and smaller as L increases (the person is farther away).

The direction that the iris needs to move is parallel to a vector drawn between the center of the display and the center of the camera. In the configuration of FIG. 1, this distance is vertically upward because the camera 14 is vertically above the center C of the display 12. The vector 29 is shown in FIG. 2 as being along the side r of the right triangle. It will be apparent, however, that if the camera is to the side of or below the display, the proper direction to move the eyes will be different, and the direction of the vector will likewise be different.

Once the magnitude and direction for modification of the eyes is known, the next step is to modify the captured image by moving the iris and eyelid in the vicinity of the iris the calculated distance, appropriately scaled for the captured image. This step is illustrated generally in FIGS. 7 and 8. In this step the downward-looking eyes 74 in FIG. 7 are adjusted upward along with an adjacent portion of the eyelids 84 by the distance M. Shown in FIG. 8 is an image 80 of the same person 72 having the eye position adjusted so that the eyes 74a have a level gaze, and the eyelids are in an adjusted location 84a. The relative adjustment of the eye position from FIG. 7 to FIG. 8 can be appreciated when viewed in combination with the outline 76 of the eye region shown in these figures. The outline of the eye region is fixed with respect to the face as a whole, while the eye position changes.

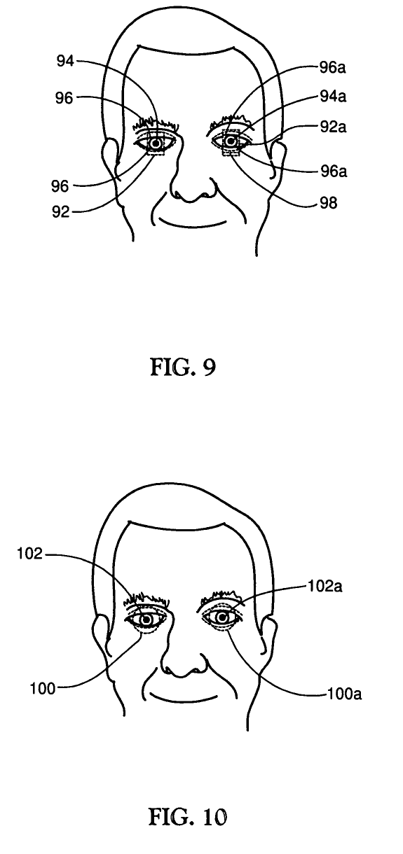

The adjustment of the eyes in the manner outlined above can be performed in several ways. Two approaches are shown in FIGS. 9 and 10. In one approach, a square or rectangular outline 92 is superimposed over the eye region of the image, so as to encompass the iris 94 and a portion of the top and bottom eyelids 96. The original image of an eye and the rectangular outline are shown on the left side of FIG. 9. This portion of the image (i.e. all pixels within the rectangular outline) are “cut” out of the image, then “pasted” Mᵢ pixels (e.g. 2 pixels) in the direction of vector 29 in FIG. 2, or “up” in this example, from its original location to an adjusted location. The adjusted location of the iris 94a and eyelid portions 96a, are shown on the right in FIG. 9.

Adjustment of the eye position in this manner leaves a “hole” 98 in the image, consisting of the 2 pixels immediately below the “pasted” image. This “hole” can be filled using an image stretch or image copy routine. For example, the pixels at the very bottom edge of the rectangular area can be stretched to fill the hole, thus providing a realistic color transition from the original to the adjusted image. Alternatively, the pixels that occupied the hole before the cut and paste operation can be copied and pasted into the same region to fill the hole.

As can be seen in FIG. 9, this parallax correction technique can create a slight discontinuity in the outline of the eyelid 96. On the one hand, where the shifting of the eye position is very small (e.g. 2 pixels), the inventor has found that this slight discontinuity may not be considered objectionable. Alternatively, the system can be configured to execute a smoothing routine to remove this discontinuity, to produce the smooth eyelid contour shown in FIG. 8. Such smoothing routines are commercially available.

Another approach that minimizes the eyelid discontinuity is shown in FIG. 10. In this approach a circular region 100 is superimposed over the eye 102, as shown on the left in FIG. 10. The iris and eyelid portions of the image within this circular region are adjusted upward in the manner described above, to the adjusted positions 100a and 102a, as shown on the right in FIG. 10. Any hole that is left by this cut and paste operation can be filled in the manner outlined above. As can be seen in FIG. 10, the round cut region 100 produces a smaller discontinuity in the line of the eyelid. This approach minimizes the discontinuity of the eyelid such that smoothing may not be needed to provide an acceptable image. However, smoothing of the eyelid line can still be performed when using the circular cut region.

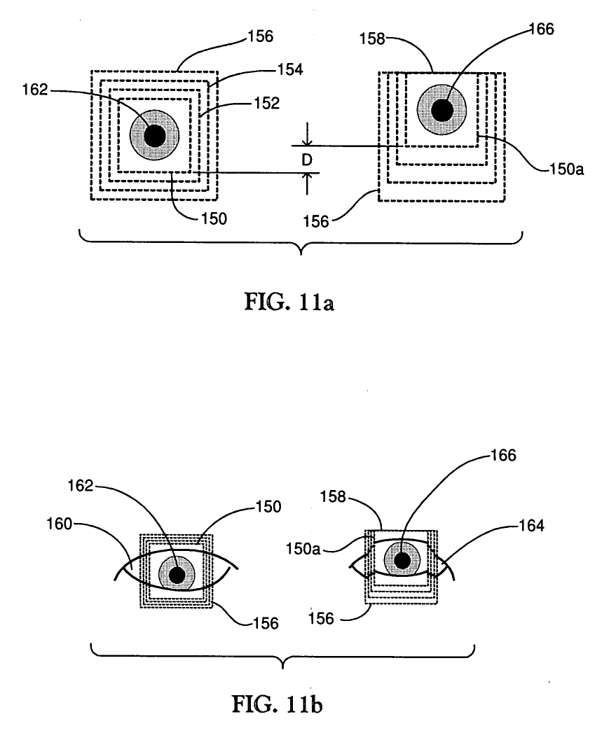

An alternative method for adjusting the position of the eyes and eyelids and smoothing the resulting image is illustrated in FIGS. 11a and 11b. Instead of using line smoothing, the inventor has found that it is possible to smooth the transition between the shifted eye position and the surrounding image by using multiple concentric cut and paste regions. A group of nested square regions that can be used in this manner are shown on the left in FIG. 11a. The innermost square 150 is intended to be centered on the eye 162, with each of the other squares 152-156 concentrically positioned around it. Each square can be some selected dimension (e.g. 1 pixel) larger in each dimension than the next smaller square. For example, if it is desired that there be 1 pixel between all boundaries of adjacent squares, the outer square 156 in FIG. 11a will have a distance of 3 pixels from each side wall to the boundary of the inner square 150. Because of this, the outer square will be 6 pixels longer on each side than the inner square. It is to be appreciated that the sizes of the squares relative to each other are shown greatly exaggerated for illustrative purposes.

To adjust the image using these concentric or nesting square regions, the position of the squares can be adjusted in the manner shown on the right in FIG. 11a. Because there are four squares with one pixel distance between them, the inner square 150 can be adjusted upward a distance D of 3 pixels to a position 150a. This distance D can be the same as the eye shift distance M calculated in the manner discussed above. The second square 152 is adjusted upward a distance of 2 pixels, and the next square 154 is adjusted upward by 1 pixel. The outer square 156 does not move. Making these adjustments will place the upper boundary of all squares along a common line 158 that is coincident with the upper boundary of the outer square 156.

The effect of this sort of adjustment is illustrated in FIG. 11b. On the left is shown the group of nested squares, including the inner square 150 and outer square 156, positioned over an eye 160 and encompassing the iris 162 and portions of the eyelids. Shown on the right in FIG. 11b is an eye 164 in which the position of iris 166 has been moved upward in the manner explained above. The outer square 156 is not moved, while the inner square is moved to position 150a, and the other squares are moved incremental distances so that all squares share the common top boundary 158. As noted above, it is to be appreciated that the size of the squares relative to the eye and to each other is greatly exaggerated in FIG. 11b for illustrative purposes.

With this type of adjustment it can be seen that the portions of the eyelid and surrounding image data in each square are only adjusted a small distance (1 pixel) relative to the adjacent squares. Consequently, the image of the eyelid is smoother than it would be if the adjustment were abrupt, using just the inner square 150. This approach provides a stretch-like function that helps remove discontinuity between the shifted eye and the surrounding image. It is to be appreciated that while the image smoothing approach suggested here is presented in terms of concentric squares, other shapes for the cut and past regions can be used. For example, concentric circles, ellipses, hexagons, pentagons, rectangles, etc. can also be used in the same manner.

The approach suggested above can be extrapolated or generalized in the following way. Two concentric regions can be defined and centered over the eye portion that is to be adjusted. The inner region can be moved the calculated distance M, while the outer region remains in a fixed location and defines a transition area between the outer region and the boundary of the inner region. While the approach discussed above moved the squares so that they shared a top boundary, this can be done differently. The outer region does not move, while the inner region does, but the inner region can move to a position that is not coincident with any boundary of the outer region. The image at the outer perimeter of the outer region is left unchanged. The “movement of distance Mᵢ” is then linearly distributed from the outer perimeter of the outer region to the outer perimeter of the inner region. In other words, the pixel positions of the image are gradually shifted between the inner and outer regions to provide a pleasing image transition. As noted above, this approach is effective whether the regions are square, circular, rectangular, or other shapes. The difference in size between the outer and inner regions can also be adjusted to improve the image.

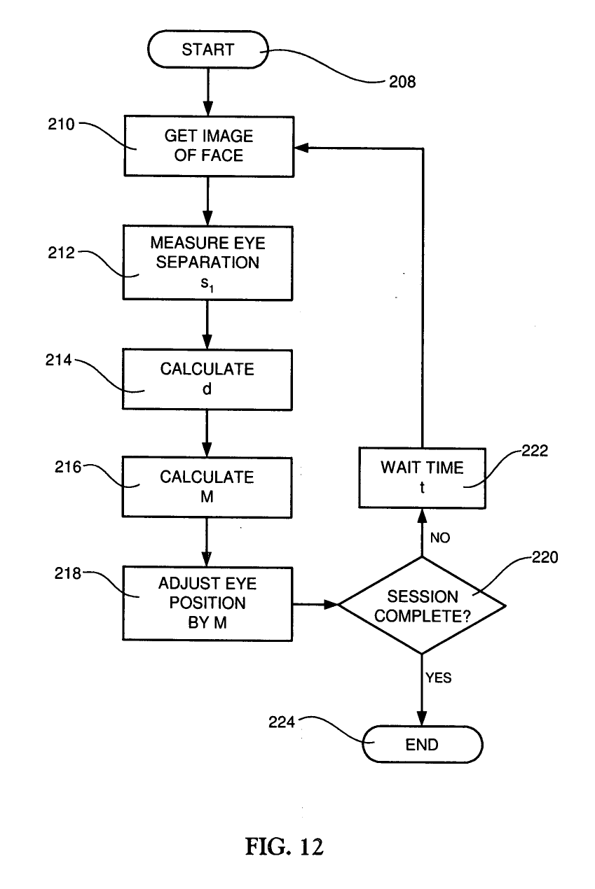

A flowchart outlining the basic steps in one embodiment of the method disclosed herein is provided in FIG. 12. As noted, once the system starts (step 208) the first step is to obtain the image of the face (step 210). Once this image is obtained, facial recognition software is used to locate the eyes and graphically measure the eye separation sᵢ (step 212). Based upon this measurement, the system is able to calculate the distance d from the display to the person (step 214) and to thereby determine the distance M that the eyes must be adjusted to provide the appearance that the user is looking at the camera (step 216). Following these steps, the system adjusts the position of the eyes in the manner outlined above (step 218). This involves cutting the image of the eye and portions of the eyelid within a geometrical region around the iris, and moving this image to a paste location that is toward the camera location.

Once the eye position adjustment has taken place, it will be apparent that there may be a need for further adjustment due to movement of the user. Consequently, the system can query whether the video phone session is completed (step 220). If not, the system can wait some time t (step 222), then return to step 210 to obtain a new image of the face, and repeat the process. It should be noted that the system can be configured not to wait to repeat the process. Instead, repositioning of the eyes can be performed continuously throughout the video phone session. Depending upon the speed of the microprocessor, repositioning of the eyes can be performed with each image frame of the live action video. This allows the appearance of eye contact to persist throughout the session. When the session is complete, as determined at step 220, the eye repositioning process ends (step 224).

The present disclosure thus describes a method for changing the perceived view direction in an image of a person's face using electronic image analysis and modification in order to provide the appearance of eye contact during a video conference. This method uses software that can analyze the image of a face and determine where the irises are, then adjust the image of the iris and the eyelids in the vicinity of the iris a calculated distance so as to give the appearance of eye contact.

It is to be understood that the above-referenced arrangements are illustrative of the application of the principles of the present disclosure. It will be apparent to those of ordinary skill in the art that numerous modifications can be made without departing from the principles and concepts of the disclosure as set forth in the claims.

What is claimed is:

1. A method for changing a perceived view direction in an image of a subject's face, comprising the steps of:
a) graphically identifying positions of the subject's eyes in the image;
b) determining a distance between the subject and a camera taking the image, based upon the positions of the eyes;
c) calculating a distance to move the eyes to provide an appearance that the eyes are looking at the camera; and
d) moving image portions of the eyes the calculated distance.

2. A method in accordance with claim 1, wherein the step of determining a distance between the subject and the camera comprises:
e) measuring a graphical distance between centers of the eyes;
f) comparing the graphical distance with a standard eye spacing of a human; and
g) determining the distance to the subject based upon the graphical distance between the eyes and optical characteristics of the camera.

3. A method in accordance with claim 1, wherein the step of calculating the distance to move the eyes comprises calculating a distance to move an iris of the eye to provide the appearance that a line from the camera to the center of the eyeball passes through a center of the iris.

4. A method in accordance with claim 1, further comprising the steps of:
e) calculating a distance between the subject and a presumed focal point at a display at a fixed location relative to the camera, based upon the distance from the camera to the subject; and
f) calculating the distance to move the eyes as being equal to
(r*e)/(2*d)
where d equals the distance between the display and the subject, r equals the distance between the camera and the presumed focal point, and e equals the diameter of a typical adult human eye.

5. A method in accordance with claim 1, wherein the step of moving image portions of the eyes comprises:
e) defining a geometric boundary encompassing graphical elements corresponding to an iris of the eye and at least a portion of an eyelid;
f) shifting a position of the graphical elements the calculated distance; and
g) graphically filling a gap between an original position of the geometric boundary and a shifted position of the geometric boundary.

6. A method in accordance with claim 5, further comprising the step of graphically smoothing image portions of the eyelids between the shifted graphical elements and adjacent non-shifted portions of the image of the face.

7. A method in accordance with claim 5, wherein the step of graphically filling the gap between the original and shifted positions of the geometric boundary comprises a step selected from the group consisting of:
h) inserting transition graphical elements into the gap; and
i) stretching existing graphical elements adjacent to the original boundary position to fill the gap.

8. A method in accordance with claim 1, further comprising the step of periodically repeating steps (a) through (d).

9. A method in accordance with claim 1, wherein the step of moving image portions of the eyes and of the eyelids comprises:
e) defining a plurality of nested geometric boundaries, including an outermost boundary, at least one inner boundary, and an innermost boundary encompassing graphical elements corresponding to an iris of the eye and at least a portion of an eyelid;
f) shifting a position of the graphical elements within the innermost boundary the calculated distance; and
g) shifting a position of graphical elements within each inner boundary and outside the next adjacent inner boundary a proportional distance that is less than the calculated distance.

10. A method in accordance with claim 9, wherein the calculated distance is selected relative to a size of the outermost boundary such that a top extreme of all nested geometric boundaries are substantially coincident after being shifted.

11. A method in accordance with claim 9, wherein the nested geometric boundaries have a shape selected from the group consisting of rectangular, square and circular.

12. A method for providing perceived eye contact in a video conference system having a video conference camera positioned a fixed distance from a video conference display, comprising the steps of:
a) graphically identifying positions of eyes of a person in a video conference image;
b) determining a distance between the person and the camera taking the image, based upon the positions of the eyes;
c) calculating a distance to move the eyes to provide an appearance that the eyes are looking at the camera and not at a center of the video conference display; and
d) moving image portions of the eyes and a region around the eyes the calculated distance.

13. A method in accordance with claim 12, wherein the step of moving image portions of the eyes and a region around the eyes comprises:
e) defining a geometric boundary encompassing graphical elements corresponding to an iris of the eye and at least a portion of an eyelid;
f) shifting a position of the graphical elements the calculated distance; and
g) graphically filling a gap between an original position of the geometric boundary and a shifted position of the geometric boundary.

14. A method in accordance with claim 13, further comprising the step of graphically smoothing image portions of the region around the eyes between the shifted graphical elements and adjacent non-shifted portions of the image of the face.

15. A method in accordance with claim 12, wherein the step of moving image portions of the eyes and of the eyelids comprises:
e) defining a plurality of nested geometric boundaries, including a fixed outermost boundary, at least one inner boundary, and an innermost boundary encompassing graphical elements corresponding to an iris of the eye and at least a portion of an eyelid;
f) shifting a position of the graphical elements within the innermost boundary the calculated distance; and
g) shifting a position of graphical elements that lie within each inner boundary and outside the next adjacent inner boundary a proportional distance that is less than the calculated distance.

16. A computer program comprising machine readable program code for causing a computing device, associated with a video conference system having a camera and a display, to perform the steps of:
a) graphically identifying eyes in an image of a human face, the image taken by the camera;
b) determining a distance between the face and the camera based upon positions of the eyes;
c) calculating a distance to move the eyes to provide the appearance that the eyes are looking at the camera and not the display; and
d) moving image portions of the eyes the calculated distance.

17. A computer program in accordance with claim 16, further comprising program code for causing the computing device to perform the steps of:
e) defining a geometric boundary encompassing graphical elements corresponding to an iris of the eye and at least a portion of an eyelid;
f) shifting a position of the graphical elements the calculated distance; and
g) graphically filling a gap between an original position of the geometric boundary and a shifted position of the geometric boundary.

18. A computer program in accordance with claim 17, wherein the step of graphically filling the gap between the original and shifted positions of the geometric boundary comprises a step selected from the group consisting of:
h) inserting transition graphical elements into the gap; and
i) stretching existing graphical elements adjacent to the original boundary position to fill the gap.

19. A computer program in accordance with claim 16, further comprising program code for causing the computing device to perform the steps of graphically smoothing image portions of the eyelid between the shifted graphical elements and adjacent non-shifted portions of the image of the face.

20. A computer program in accordance with claim 16, further comprising program code for causing the computing device to perform the steps of:
e) defining a plurality of nested geometric boundaries, including a fixed outermost boundary, at least one inner boundary, and an innermost boundary encompassing graphical elements corresponding to an iris of the eye and at least a portion of an eyelid;
f) shifting a position of the graphical elements within the innermost boundary the calculated distance; and
g) shifting a position of graphical elements that lie within each inner boundary and outside the next adjacent inner boundary a proportional distance that is less than the calculated distance.
